(19) United States
(12) Patent Application Publication
(10) Pub. No.: US 2014/0223388 A1
(43) Pub. Date: Aug. 7, 2014

(54) DISPLAY CONTROL METHOD AND APPARATUS

(71) Applicant: Samsung Electronics Co., Ltd., Gyeonggi-do (KR)

(72) Inventors: Kyungtae KIM, Gyeonggi-do (KR); Yoonjeong CHOI, Seoul (KR)

(73) Assignee: Samsung Electronics Co., Ltd., Gyeonggi-do (KR)

(21) Appl. No.: 14/168,238

(22) Filed: Jan. 30, 2014

(30) Foreign Application Priority Data
Feb. 4, 2013 (KR) 10-2013-0012563

(51) Int. Cl. G06F 3/0488

(52) U.S. Cl. CPC G06F 3/0488
USPC 715/863

(57) ABSTRACT

A method is provided for adjusting a touch screen display of a terminal, the method including adjusting, by a processor, a brightness level of the display based on a direction of a touch gesture performed in a predetermined region of the display; adjusting a contrast level of the display in response to a first characteristic included in the touch gesture, when the touch gesture progresses in a direction of increasing the brightness level; and adjusting a tone level of the display in response to a second characteristic included in the touch gesture, when the touch gesture progresses in a direction of decreasing the brightness level.

### CLAIM OF PRIORITY

This application claims the benefit under 35 U.S.C. §119(a) of a Korean patent application filed on Feb. 4, 2013 in the Korean Intellectual Property Office and assigned Serial No. 10-2013-0012563, the entire disclosure of which is hereby incorporated by reference.

### TECHNICAL FIELD

The present disclosure relates to a method and apparatus for controlling communications terminals, and more particularly to a method and apparatus for adjusting various touch screen characteristics of the communications terminals.

### BACKGROUND

With the widespread adoption of touch screens as primary means for user input in mobile devices, the key criterion for determining the competitiveness of mobile devices has moved from hardware specification to User Interface (UI) or user experience (UX) design. In response to this trend, smart phone manufacturers have started to use UX design differentiation strategies as their competitive weapon of choice. Some manufacturers have even gone so far as to offer UX upgrades instead of Operating System (OS) upgrades.

More particularly, the term user experience (UX) refers to a person's emotions about using a particular mobile device. As such, UX highlights the experiential, affective, and valuable aspects of human-computer interaction. UX is settled as a technology of humanization based on context beyond the level of graphical refinement. In recent times, intensive research has been conducted on ways to improve the UX of mobile devices. However, the need still exists for new methods and techniques for enhancing the UX of mobile devices.

### SUMMARY

The present disclosure addresses this need. According to one aspect of the disclosure, a method for adjusting a touch screen display of a terminal, the method comprising: adjusting, by a processor, a brightness level of the display based on a direction of a touch gesture performed in a predetermined region of the display; adjusting a contrast level of the display in response to a first characteristic included in the touch gesture, when the touch gesture progresses in a direction of increasing the brightness level; and adjusting a tone level of the display in response to a second characteristic included in the touch gesture, when the touch gesture progresses in a direction of decreasing the brightness level.

According to another aspect of the disclosure, a method for controlling multiple properties of an electronic device's display by using a single touch gesture is provided, the method comprising: responsive to detecting a touch gesture in a predetermined region of the display, entering by the electronic device into a primary adjustment mode, wherein the electronic device is configured to use the touch gesture as a basis for changing a first property of the display when the electronic device is in the primary adjustment mode; and while the touch gesture is being performed, and responsive to detecting that the touch gesture possesses a predetermined characteristic, exiting the primary adjustment mode and entering a complementary adjustment mode by the electronic device, wherein the electronic device is configured to use the touch gesture as a basis for changing a second property of the display when the electronic device is in the complementary adjustment mode.

According to yet another aspect of the disclosure, an apparatus is provided that includes a display and a processor configured to: responsive to detecting a touch gesture in a predetermined region of the display, enter into a primary adjustment mode, wherein the processor is operable to use the touch gesture as a basis for changing a first property of the display when the processor is in the primary adjustment mode; and while the touch gesture is being performed, responsive to detecting that the touch gesture possesses a predetermined characteristic, exit the primary adjustment mode and enter a complementary adjustment mode, wherein the processor is operable to use the touch gesture as a basis for changing a second property of the display when the processor is in the complementary adjustment mode.

### BRIEF DESCRIPTION OF THE DRAWINGS

FIG. 1 is a block diagram of an apparatus, in accordance with aspects of the disclosure;

FIG. 2 is a flowchart of a process for controlling the display of the apparatus, in accordance with aspects of the present disclosure;

FIG. 3 is a flowchart of a process for configuring brightness adjustment mode and complementary adjustment mode capabilities of the apparatus;

FIG. 4 is a diagram of an example technique for adjusting screen brightness, tone, and contrast, in accordance with aspects of the present disclosure;

FIG. 5 is a diagram of another example technique for adjusting screen brightness, tone, and contrast, in accordance with aspects of the present disclosure;

FIG. 6 is a diagram of yet another example technique for adjusting screen brightness, tone, and contrast, in accordance with aspects of the present disclosure;

FIG. 7 is a diagram of yet another example technique for adjusting screen brightness, tone, and contrast, in accordance with aspects of the present disclosure;

FIG. 8 is a diagram depicting an example of a first interface for configuration of a second interface for adjusting screen brightness in accordance with aspects of the present disclosure;

FIG. 9 is a block diagram illustrating an example of a graphics system for adjusting screen brightness, tone, and contrast, in accordance with aspects of the present disclosure;

FIG. 10 is a block diagram illustrating another example of a graphics system for adjusting screen brightness, tone, and contrast, in accordance with aspects of the present disclosure; and

FIG. 11 is a block diagram illustrating yet another example of a graphics system for adjusting screen brightness, tone, and contrast, in accordance with aspects of the present disclosure.

### DETAILED DESCRIPTION

Aspects of the disclosure are described with reference to the accompanying drawings in detail. The same reference numbers are used throughout the drawings to refer to the same or like parts. Detailed description of well-known functions and structures incorporated herein may be omitted to avoid obscuring the subject matter of the present disclosure.

The specification and drawings are to be regarded in an illustrative rather than a restrictive sense in order to help understand the present disclosure. Various modifications and changes can be made thereto without departing from the scope of the disclosure.

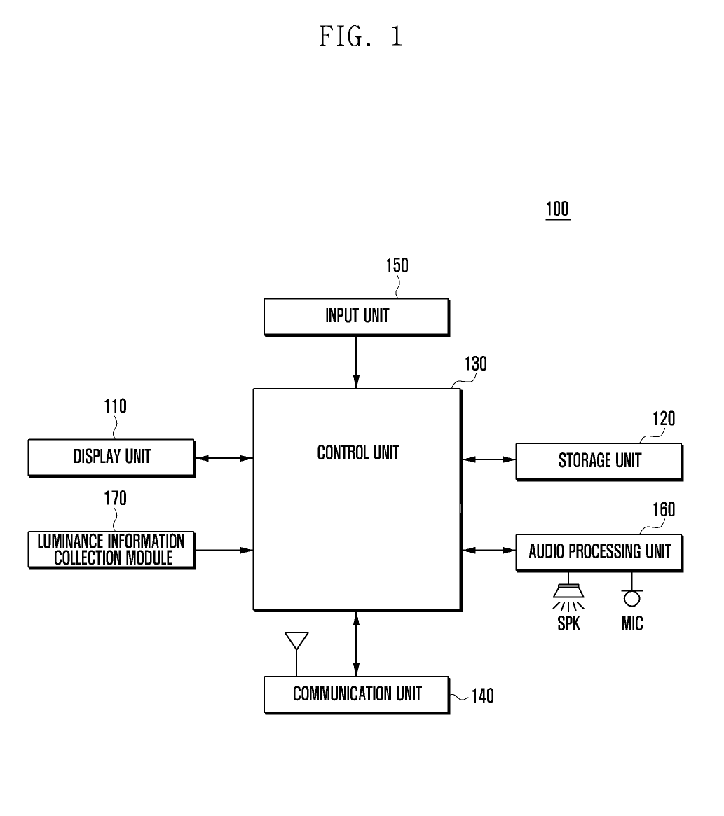

A description is made of the structure of the present disclosure in detail with reference to accompanying drawings. FIG. 1 is a block diagram of a terminal 100 according to aspects of the disclosure. Referring to FIG. 1, the terminal 100 may include a display unit 110, a storage unit 120, a communication unit 140, an input unit 150, an audio processing unit 160, a luminance information collection module 170, and a control unit 130. The terminal 100 may further include a digital broadcast module for receiving and playing digital broadcast content (e.g. DMB and DVB) and a camera module for shooting still images or video.

The display unit 110 may be configured to output screens provided by different applications running on the terminal 100. For example, the display unit 110 can display screens of a message function, email function, Internet function, multimedia function, search function, communication function, ebook function, video playback function, still/motion picture shooting function, digital broadcast function, audio playback function (e.g. MP3), widget function, memo function, game function, etc. The display unit 110 may be implemented with one of Liquid Crystal Display (LCD), Organic Light Emitting Diodes (OLED), and/or any other suitable type of technology.

In one aspect of the present disclosure, the display unit 110 may provide touch-based input interface. For example, the display unit 110 may receive a user's touch and/or a touch gesture (hereinafter, commonly referred to as touch input), generate a signal indicating the touch input, and provide the signal to the control unit 130. In one aspect of the present disclosure, the display unit 110 may be divided into an execution information display region (hereinafter, referred to as display region) for displaying screens associated with different applications running on the terminal 100 and a state information display region (hereinafter, referred to as indicator region) for displaying the state information of the terminal 100. The display unit 110 may adjust the brightness of the screen according to touch input received in the indicator region.

The storage unit 120 stores various programs and data to be executed and processed in the terminal 100 and may include at least one of a volatile memory device and a non-volatile memory device. For example, the storage unit 120 may store an Operating System (OS) and programs and data associated with control of the screen brightness, tone, and contrast of the display unit 110. In some implementations, the software and/or data may be configured to perform a screen brightness adjustment (or another type of screen adjustment) by using the indicator region. The storage unit 120 may store various settings associated with the screen brightness adjustment capabilities of the terminal 100. For example, the storage unit 120 may store the information identifying a brightness and contrast adjustment method currently in use by the terminal 100, default screen brightness, contrast, and tone information, and/or any other suitable type of information. The storage unit 120 may also store configuration screen information for configuring the brightness, tone, and contrast.

The communication unit 140 is a component included when the terminal 100 supports communication function and thus may be omitted in case of the terminal supporting no communication function. The communication unit 140 may include electronic circuitry for establishing a communication channel with a base station of a cellular network, and/or a node of any other suitable type of communications network.

The input unit 150 may include a keyboard, keypad, and key buttons, and/or any other suitable type of input component. In some implementations, the input unit 150 and the display unit 110 may be integrated together as a single unit. Particularly, according to aspects of the present disclosure, the input unit 150 may generate various key input signals for controlling the brightness adjustment mode and complementary adjustment modes. The key input signals may be generated by means of the hardware keys arranged on the front or side surface of the terminal 100 or, when the display unit 100 is touch screen-enabled, by virtual keys provided on the touch screen.

The audio processing unit 160 may include a speaker (SPK) for outputting sound associated with the operation of the terminal 100. The audio processing unit 160 may support audio data collection function with a microphone (MIC). In some implementations, the audio processing unit 160 may output a beep sound, melody, or announcement (hereinafter, referred to as notification sound) for indicating switch from the brightness adjust mode to a complementary adjustment mode. Thus, the audio processing unit 160, in some instances, may be configured to provide audio feedback in response to an adjustment of brightness (or another screen characteristic) that is made by a user.

The luminance information collection module 170 includes at least one of a luminance sensor for sensing the ambient brightness in the terminal's 100 environment and a circuit or module for adjusting the brightness of the display unit 110 automatically based on the sensed brightness. In some implementations, the luminance information collection module 170 may collect the ambient luminance information and send the collected information to the control unit 130 to adjust the brightness of the display unit 110. The luminance information collection module 170 may be configured to change the brightness in adaptation to the detected ambient brightness. In some implementations, the luminance information collection module 170 may collect the ambient luminance information when the auto-brightness button and/or complementary adjustment mode activation button is turned on.

The control unit 130 may control various aspects of the operation of the terminal 100.The control unit 130 may include a processor (e.g., an ARM-based processor, an x86 based processor, or a MIPS-based processor), an FPGA, and/or any other suitable type of electronic circuitry. In some implementations, the control unit 130 may perform a screen brightness adjustment function.

In one aspect, the control unit 130 may associate the right end of the indicator region with a highest level of screen brightness and the left end of the indicator region with a lowest level of screen brightness. In operation, the control unit 130 may detect a touch gesture input in the indicator region of the display unit 110. If the touch gesture progresses up to right end of the indicator region (highest level of the screen brightness) and stays over predetermined time, the processor may transition the terminal 100 into a complementary adjustment mode. In some implementations, the control unit 130 may output an alarm sound to notify of switching from the brightness adjustment mode to the complementary adjustment mode, particularly contrast adjustment mode, and display notification message notifying of switching from the brightness adjustment mode to the contrast adjustment mode of the display unit 110. The notification message may be displayed with the brightness level and the contrast or tone level in the format of percentage. A brightness indicator and a contrast or tone indicator may be expressed with different colors. The brightness indicator and the contrast or tone indicator also may be expressed with different color depths.

Although the description is directed to the case where the touch gesture has progressed up to the right end of the screen in the state that the screen brightness level is increasing, the touch gesture may stop at a certain position before reaching the right end of the indicator region and stay there over predetermined time to adjust the contrast in the contrast adjustment mode of the complementary adjustment mode. In other words, a transition into the adjustment mode may be triggered by the touch gesture stopping at any suitable position in the indicator region, in some embodiments.

In one aspect of the present disclosure, the control unit 130 configures the right end of the indicator region as the highest level of the screen brightness and the left end of the indicator region as the lowest level of the screen brightness. The control unit 130 detects a touch gesture on the indicator region of the display unit 110 and, if the touch gesture progresses up to left end of the indicator region (lowest level of the screen brightness) and stays over predetermined time, regards this as the entry into the complementary adjustment mode. If the touch gesture is maintained after the entry into the complementary adjustment mode, the control unit 130 controls the terminal to enter the tone adjustment mode and increase the tone level in proportion to the time duration of the touch. As aforementioned, the control unit 130 may output at least one of an alarm sound and notification message to notify the user of switching from the brightness adjustment mode to the complementary adjustment mode Although the description is directed to the case where the touch gesture has progressed up to the left end of the screen in the state that the touch gesture progresses in the way of decreasing the screen brightness, the touch gesture may stop at a certain position before reaching the left end of the indicator region and stay there over predetermined time to adjust the tone level in the tone adjustment mode of the complementary adjustment mode.

Additionally or alternatively, in another aspect of the present disclosure, the control unit 130 configures a certain point biased to the right part of the indicator region on which the touch gesture progresses as the backlight's highest brightness level point. If the touch gesture progresses to the right on the indicator region to pass the highest brightness point, the control unit 130 regards this as the entry into the complementary adjustment mode, particularly contrast adjustment mode. As the touch gesture continues progressing to the right past the highest brightness point, the control unit 130 increases the contrast level according to the progress of the touch gesture. If the touch gesture progresses from right to left in the complementary adjustment mode, particularly contrast adjustment mode, the control unit 130 may decrease the contrast level in proportion to the distance progressed to the left. The contrast has the range of the lowest level at the point where the contrast adjustment mode starts on the indicator region and the highest level at the right end of the indicator region. As described above, the control unit 130 may output an alarm sound and present notification message to notify the user of the switching between the brightness adjustment mode and complementary adjustment mode.

In some instances, the screen brightness range of the screen brightness adjustment mode may be fixed or variable. In one example, the control unit 130 may adjust brightness based on a touch gesture performed in a middle portion of the indicator portion, while contrast and color tone levels are controlled by performing touch gestures in a left and right portion of the indicator portion that are situated on opposite sides of the middle portion. That is, the control unit 130 configures the screen brightness control range from a certain point between the highest brightness level point and the right end and another point between the lowest brightness level point and the left end. The right margin portion of the highest brightness level point is used as the portion for the contrast adjustment mode of the complementary adjustment mode, and the left margin portion of the lowest bright level point is used for the tone adjustment mode of the complementary adjustment mode. In the case that the screen brightness range is variable, if the current brightness level is 5, the control unit 130 may configure such that the point where the user makes a touch is set to brightness level of 5. If the current bright level is 2, the control unit 130 may configure such that the point where the user makes a touch is set to brightness level of 2. Thus, in some instances, the location of a first touch of a touch gesture in the indicator region may correspond to the current screen brightness (or another property) and in other instances, the first touch of the touch gesture may correspond to a brightness value (or another property value) that is determined independently of the current state of the terminal 100.

Additionally or alternatively, in yet another aspect of the disclosure, the control unit 130 may configure a certain point biased to the left part of the indicator region as the point of the lowest brightness level of the backlight. In this example, the brightness range is fixed. If a touch gesture progresses to the left so as to pass the lowest brightness level point, the control unit 130 determines the entry into the complementary adjustment mode, particularly the tone adjustment mode. The control unit 130 decreases the tone level according to the progress of the touch gesture after passing the lowest brightness level point. If the touch gesture changes in direction so as to progresses to the right, the control unit 130 may increase the tone level in proportion to the progressing distance to the right. At this time, the control unit configures the tone level range with the highest level at the point where the tone adjustment mode starts on the indicator region and the lowest level at the left end of the indicator region. As aforementioned, the control unit 130 may output an alarm sound or change the color of the indicator region to indicate that the terminal 100 has transitioned into the complementary adjustment mode.

Additionally or alternatively, in yet another aspect of the disclosure, if a touch gesture progressing to the right on the indicator region changes in direction to the downward, the control unit 130 regards this as the entry into the complementary adjustment mode, particularly contrast adjust mode. Since the touch gesture has been progressing to the right part of the indicator region in the brightness adjust mode, this is determined as the entry into the contrast adjustment mode. The control unit 130 increases the contrast level as the touch gesture progresses to the downward on the display unit 110. If the touch gesture progressing downward changes in direction to upward in the contrast adjustment mode, the control unit 130 decreases the contrast level in proportion to the progressing distance to the upward direction since the brightness adjustment mode is active even when the touch gesture changes in progressing direction from the horizontal direction to the downward direction. The contrast range is configured to have the lowest level at the top end of the display area of the display unit 110 and the highest level at the bottom end of the display area. As aforementioned, the control unit 130 may output an alarm sound and present notification message to notify the user of the switching between the brightness adjustment mode and complementary adjustment mode. In the contrast adjustment mode, the control unit 130 may control the display unit to display an brightness indicator indicating the current brightness level and an contrast indicator indicating the adjusted contrast level. For example, the control unit 130 sets the contrast level to 0% for the touch gesture placed at the top end and at 100% for the touch gesture placed at the bottom end of the display area of the display unit 110.

Additionally or alternatively, in yet another aspect of the disclosure, if a touch gesture progressing to the left on the indicator region turns the direction to downward on screen of the display unit 110, the control unit 130 regards this as the entry into the complementary adjustment mode. Since the touch gesture has been progressing to the left, the control unit 130 determines that the complementary adjustment mode is the tone adjustment mode. As the touch gesture progresses in a downward direction, the control unit 130 decreases the tone level. If the touch gesture progressing downward reverses its direction and starts progressing in an upward direction, the control unit 130 increases the tone level in proportion to the progressing distance. Since the brightness adjustment mode is active yet even when the progressing direction changes from horizontal direction to a downward direction In some instances, the tone level range may be configured to have the highest level at the top end point of the display area of the display unit 110 and the lowest level at the bottom end point of the display area. As aforementioned, the control unit 130 may output an alarm sound to notify of the switching from the brightness adjustment mode to the complementary adjustment mode, particularly, the tone adjustment mode. In the tone adjustment mode, the control unit 130 may control the display unit to display an indication window indicating the tone level. For example, the control unit 130 controls such that the tone level is set to 100% for the touch gesture placed at the top end and 0% for the touch gesture placed at the bottom end of the display area of the display unit 110.

Although the above examples involve the case where the touch gesture progressing to the left changes in a downward direction, relative to the indicator region, it will be understood that the touch gesture which progresses to reach the left end (brightness level 1) and then turns to the downward direction may also trigger entry into the complementary tony adjustment mode. In that regard, the complementary adjustment mode of the terminal, in some aspects, may be selected based on an initial direction of the first gesture along a first line (or set of lines), such as lines that are substantially horizontal, and whether to increase or decrease the tone or contrast of the display may be determined based on a subsequent direction of the touch gesture along a second line (or set of lines), such as lines that are substantially vertical (or otherwise transverse to the first set of line(s)). Moreover, in this example, the shift from the initial direction to the subsequent direction may be a triggering event, which when detected by the control unit 130, causes the terminal 100 to transition into a complementary adjustment mode.

Additionally or alternatively, according to yet another aspect of the disclosure, the control unit 130 may configure a certain point biased to the right on the indicator region as the highest brightness level point of the backlight. If the touch gesture progressing to the right stops at a certain point and stays there over predetermined time, the control unit 130 regards this as entry into the complementary adjustment mode, particularly the contrast adjustment mode. After entering the complementary adjustment mode, if the touch gesture progresses to the left part of the indicator region, the control unit 130 regards this as the entry into the contrast adjustment mode and thus increases the contrast according to the progress of touch gesture to the right. If the touch gesture changes in progressing direction to the left part of the indicator region while increasing the contrast level in the complementary adjustment mode, the control unit 130 decreases the contrast level in proportion to the distance progressed to the left. The contrast range is configured to have the lowest level at the complementary adjustment mode entry point on the indicator region and the highest level at the right end point of the indicator region. As aforementioned, the control unit 130 may output an indication of the transition from the adjustment mode to the complementary adjustment mode by sounding an alarm, changing the color of the indicator region, and/or performing any other suitable action.

Additionally or alternatively, according to yet another aspect of the present disclosure, the control unit 130 may configure a certain point biased to the left on the indicator region as the lowest brightness level point of the backlight. If the touch gesture progressing to the left stops at a certain point and stays there over predetermined time, the control unit 130 regards this as entry into the complementary adjustment mode, particularly the tone adjustment mode. After entering the complementary adjustment mode, if the touch gesture progresses to the left part of the indicator region, the control unit 130 regards this as the entry into the tone adjustment mode and thus decreases the tone according to the progress of touch gesture to the left. If the progress direction of the touch gesture changes to the right part of the indicator region while decreasing the tone level in the complementary adjustment mode, the control unit 130 increases the tone level in proportion to the distance progressed to the right. The tone range is configured to have the highest level at the complementary adjustment mode entry point on the indicator region and the lowest level at the left end point of the indicator region. It should be noted that the tone adjustment mode is different from the brightness adjustment mode. In the brightness adjustment mode, the brightness of a backlight (or another light source or plurality of light sources) is adjusted, whereas in the tone adjustment mode an attenuation component of the display may be manipulated so that pixels appear darker or brighter (without varying backlight brightness).

Additionally or alternatively, in accordance with aspects of the disclosure, if the auto-brightness or auto-tone/contrast button is turned on to adjust the brightness, tone, and contrast, the control unit 130 adjusts the brightness, tone, and contrast in adaptation to the luminance information collected by the luminance information collection module 170. For example, if the luminance information indicates that the ambient brightness is very dart, the control unit 130 adjusts the brightness level of the screen of the display unit 110 to a dark level and decrease the tone level of the screen. If the luminance information indicates that the ambient brightness is very bright, the control unit 130 increases the brightness level of the screen of the display unit 110 while also increasing the contrast level of the screen.

In the case of adjusting the tone or contrast of the screen in the complementary adjustment mode, if a touch gesture is detected on the indicator region, the control unit 130 determines whether the touch gesture is made for adjusting the screen brightness or presenting the submenu. For example, if the touch gesture is a swing gesture made horizontally, the control unit 130 regards the touch gesture as the screen brightness increase event and, if the touch gesture progresses in a downward direction, as the submenu presentation event so as to present the submenu.

In some instances, the control unit 130 may differentiate between the screen brightness adjustment request gesture and submenu presentation request gesture and execute the task of the determined the gesture. The control unit 130 increases the contrast level according to the touch time when the touch gesture progresses to the highest brightness point and then triggers entry into the contrast adjustment mode, decreases the tone according to the touch time when the touch gesture progress to the lowest brightness point and then triggers entry into the tone adjustment mode. At this time, the tone adjustment may be performed to darken the colors displayed by the display unit 110.

In some implementations, if the touch gesture is maintained over predetermined time at a certain position of the indicator region in the screen brightness adjustment mode or complementary mode, the screen brightness may be returned to the default state. In some instances, the initialization may be performed before or after the entry of the screen brightness adjustment mode or complementary adjustment mode.

In some instances, the control unit 130 also performs other control operations related to the typical functions of the terminal 100. For example, the control unit 130 may control the execution of applications and the display of data. The control unit 130 may also receive various input signals corresponding to the touch gestures made on the screen (e.g. swing input, drag input, flick input, tap input, etc.) and control corresponding functional operations. The control unit 130 also may control such that the screen has only the display area but not the indicator area depending on the executed application.

The terminal 100 as configured in FIG. 1 may be any touch screen-enabled electronic device. For example, the terminal may include a mobile communication terminal operating with various communication protocols corresponding to the communication systems, Portable Multimedia Player (PMP), digital broadcast player, Personal Digital Assistant (PDA), music player (e.g. MP3 player), portable game console, a desktop computer, smartphone, navigation device, and/or any other suitable type of device.

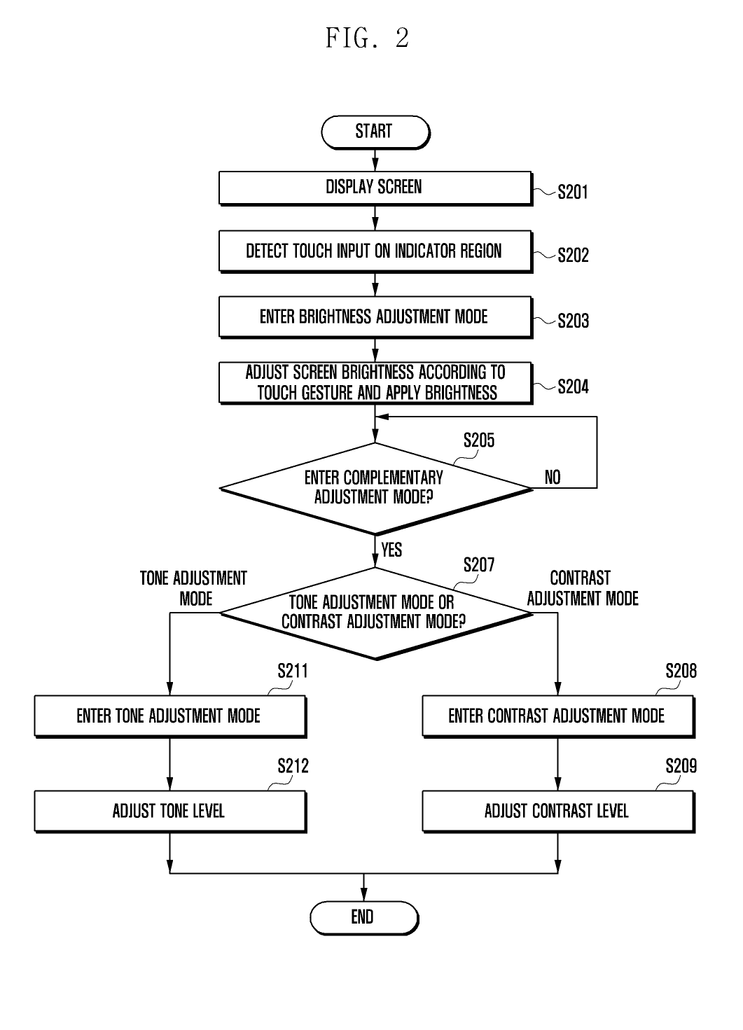

FIG. 2 is a flowchart illustrating a display control method according to aspects of the disclosure. Referring to FIG. 2, the control unit 130 first controls the display unit 110 to display a screen at step S201. For example, the control unit 130 may cause the display unit 110 to display any of a lock screen, standby screen, messaging application execution screen, communication application execution screen, web browser application execution screen, map application execution screen, diary application execution screen, phonebook application execution screen, and other application execution screens. In some implementations, the control unit 130 may cause the display unit 110 to divide the screen into an indicator region and a display region.

At step S202, the control unit 130 detects a touch gesture in the indicator region. At step S203, the control unit 130 transitions the terminal 100 into a brightness adjustment mode for configuring screen brightness in response to the touch gesture. In some implementations, the control unit 130 may transition the terminal 100 into the brightness adjustment mode only when the touch gesture is performed in the indicator region. Screen brightness, in some instances, may refer to luminance of a backlight or another light source (or light sources) that are part of the display unit 110.

At step S204, the control unit 130 changes the current screen brightness of the display unit 110based on a progress of the touch gesture along one or more predetermined lines in the indicator region. Each line, as noted above, may connect a point in the indicator region associated with highest screen brightness and a point in the indicator region that is associated with lowest screen brightness. More particularly, in some instances, the control unit 130 may incrementally change the brightness based on the distance between a starting touch of the gesture and a current touch of the gesture. For example, the control unit 130 may increase/decrease the brightness according to the touch gesture in such a way that the brightness increases if the touch gesture is performed in a right-side direction and decreases if the touch gesture is performed in a left-side direction. For example, if the current brightness level is 3 and if a current touch point of the gesture corresponds to the brightness level 5 on the indicator region, the control unit 130 may increase the brightness level from level 3 to level 5. The touch gesture may further progress to the right to increase the brightness level to the level 6 or to the left to decrease the brightness level to the level 1. In this example, the highest brightness level 6 may be associated with a point in the indicator region that is located to the right of the center of the indicator region and the lowest brightness level may be associated with a point located to the left of the center of the indicator region.

At step S205, the control unit 130 determines whether terminal 100 should enter into a complementary adjustment mode based on the gesture detected at step S202. In some implementations, the terminal 100 may be transitioned into the complementary mode only if the gesture possesses one or more predetermined characteristics. The characteristics may include a location of a touch that is part of the touch gesture, duration of the touch, direction of the gesture, and/or any other suitable characteristic. For example, if the brightness reaches the level 6 as the highest brightness level or level 1 as the lowest brightness level at step S204 and then the touch is maintained over predetermined time, the control unit 130 may treat this as a trigger for entering into the complementary adjustment mode at step S205. Although in this example the complementary adjustment mode is entered into when the touch is maintained over predetermined time at the highest brightness level 6, in other examples the complementary adjustment mode entry may be triggered when the touch is maintained over the predetermined time at the brightness level 5.

As noted above, in some implementations, a point in the indicator region may be designated as a trigger point for entering into the complementary adjustment mode. Only when the user gesture passes (or reaches) that trigger point, the terminal 100 may enter into the complementary brightness mode. In some instances, the trigger point may be one that is associated with the highest brightness level available, lowest brightness level available, or any brightness level in-between. Additionally or alternatively, any point in the indicator region may be used as a trigger point.

Additionally or alternatively, in some implementations, a shift in the direction of the touch gesture may cause the terminal 100 to transition into the complementary mode. For example, the control unit 130 may transition the terminal 100 into the complementary adjustment mode in response to the gesture changing its trajectory from being substantially horizontal to substantially vertical. Additionally or alternatively, in some implementations, the control unit 130 may transition the terminal 100 into the complementary adjustment mode in response to the gesture exiting the indicator region and venturing into display region of the display unit 110.

It should be noted that it in some instances, any changes to the brightness level that are determined based on the touch gesture (regardless of whether they are enacted or not) may be discarded. Alternatively, in some instances, any changes to the brightness level that are determined based on the touch gesture (regardless of whether they are enacted or not) may be enacted.

At step 207, the processor 130 determines whether to enter into a complementary tone adjustment mode or complementary contrast adjustment mode based on a characteristic of the touch gesture detected at step 202. For example, if it is determined that the touch gesture progresses in a direction of decreasing the brightness level of the display unit, the control unit 130 causes the terminal 100 to enter the tone adjustment mode. Alternatively, if it is determined that the touch gesture progresses in a direction of increasing the brightness level of the display unit, the control unit 130 causes the terminal 100 to enter the contrast adjustment mode.

In some implementations, the touch gesture is considered to progress in a direction of decreasing brightness when the distance between the user's finger and a point in the indicator screen associated with the maximum brightness increases while the distance between the user's finger and the point on the indicator screen associated with the minimum brightness decreases. Conversely, in some implementations, the touch gesture is considered to progress in a direction of increasing brightness when the distance between the user's finger and a point in the indicator screen associated with the minimum brightness increases while the distance between the user's finger and the point on the indicator screen associated with the maximum brightness decreases.

At step 208, the terminal 100 enters the complementary contrast adjustment mode. At step 209, the current contrast level of the display unit 110 is changed to a new level based on the touch gesture.

At step 211, the terminal enters the complementary tone adjustment mode. At step 212, the current tone level of the display unit 110 is changed to a new level based on a characteristic of the touch gesture. It should be noted that changing the tone level in some instances may involve causing the colors displayed by the display unit 110 to appear brighter or darker by manipulating attenuation component(s) that filter light produced by a backlight or another suitable light source.

More specifically, according to one example, if it is determined that the touch gesture has stayed at a location in the indicator region that is associated with a predetermined brightness level (e.g., the highest brightness level, a brightness level lower than the highest brightness level, etc.) over predetermined time so as to enter the complementary adjustment mode, the control unit 130 controls the display unit 110 to enter the contrast adjustment mode at stays 208. The control unit 130 then increases the contrast level of the display unit 110 in proportion to the time for which the touch gesture is maintained. Note that one can only increase the contrast, but not decrease it because the other side of the indicator region is used for entering into tone mode.

Additionally or alternatively, according to another example, if it is determined that the touch gesture has progressed to the right after passing the highest screen brightness level indication point, the control unit 130 controls the display unit 110 to enter the contrast adjustment mode at step S208. The control unit 130 increases the contrast level in proportion to the progressing distance to the right at step S209. At this time, the control unit 130 also determines if the touch gesture progressing to the right turns the direction oppositely to the left such that the contrast level decreases. Thus, in this example, the contrast level is changed based on direction and distance traveled by the gesture, relative to a predetermined point in the indicator screen. It should be noted that in this example, the touch gesture moves along the one or more lines in the indicator screens that are used for controlling brightness, as discussed with respect to step 204.

Additionally or alternatively, in accordance with yet another example, if it is detected that the touch gesture progressing to a direction in the way of increasing the brightness (including the highest brightness level) turns the direction to the downward below the indicator region, the control unit 130 controls the display unit 110 to enter the contrast adjustment mode at step S208. The control unit 130 increases the contrast level in proportion to the progressing distance of the touch gesture in the downward direction at step S209. At this time, the control unit 130 also determines if the touch gesture progressing downward turns the direction to the upward direction. The control unit 130 controls the display unit to apply the contrast level changes continuously at step S210.

Additionally or alternatively, in accordance with yet another example, if the touch gesture progressing to the right stops and stays at a certain point over predetermined time, the control unit 130 controls the display unit 110 to enter the complementary adjustment mode and, if the touch gesture progresses further to the right from the stopped position, controls the display unit 110 to enter the contrast adjustment mode at step S208. The control unit 130 increases the contrast level in proportion to the progressing distance to the right on the indicator region at step S209. At this time, the control unit 130 also determines if the touch gesture progressing to the right turns the direction to the left such that the contrast level decreases. The control unit 130 controls the display unit 110 to apply the checked contrast level changes continuously at step S210. The contrast level range is configured from the point where the display unit 110 enters the complementary adjustment mode on the indicator region (lowest contrast level point) to the right end (highest contrast level point).

Additionally or alternatively, in accordance with yet another example, if the touch gesture passing the point corresponding to the lowest screen brightness level of the backlight and further progressing to the left is detected, the control unit 130 controls the display unit 110 to enter the tone adjustment mode at step S211. The control unit 130 decreases the tone level in proportion to the progressing distance to the left part of the indicator region at step S212. At this time, the control unit 130 also increases the tone level if the touch gesture progresses from the left to the right. The control unit 130 controls the display unit 110 to apply the tone level changes continuously in correspondence to the touch gesture.

Additionally or alternatively, according to yet another example, if the touch gesture progressing in the way of decreasing the brightness level (including the lowest brightness level) on the indicator region turns the progressing direction downward, the control unit 130 controls the display unit 110 to enter the tone adjustment mode at step S211. The control unit 130 decreases the tone level in proportion to the progressing distance of the touch gesture in a downward direction at step S212. At this time, the control unit 130 also increases the tone level if the touch gesture progresses from in the upward direction. The control unit 130 controls the display unit 110 to apply the tone level changes continuously in correspondence to the touch gesture.

Additionally or alternatively, according to yet another example, if the touch gesture progressing to the right part of the indicator region stops and stays at a certain point over predetermined time in the brightness adjustment mode and then the touch gesture further progresses to the right from the stop point, the control unit 130 controls the display unit 110 to enter the tone adjustment mode at step S211. The control unit 130 increases the tone level in proportion to the progressing distance to the right part of the indicator region at step S212. At this time, the control unit 130 also determines if the touch gesture progressing to the right turns the direction oppositely to the left such that the tone level decreases. The control unit 130 controls the display unit 110 to adjust the tone level continuously in correspondence to the touch gesture. The tone level adjustment range is configured from the complementary adjustment mode entry point to the right end of the indicator region.

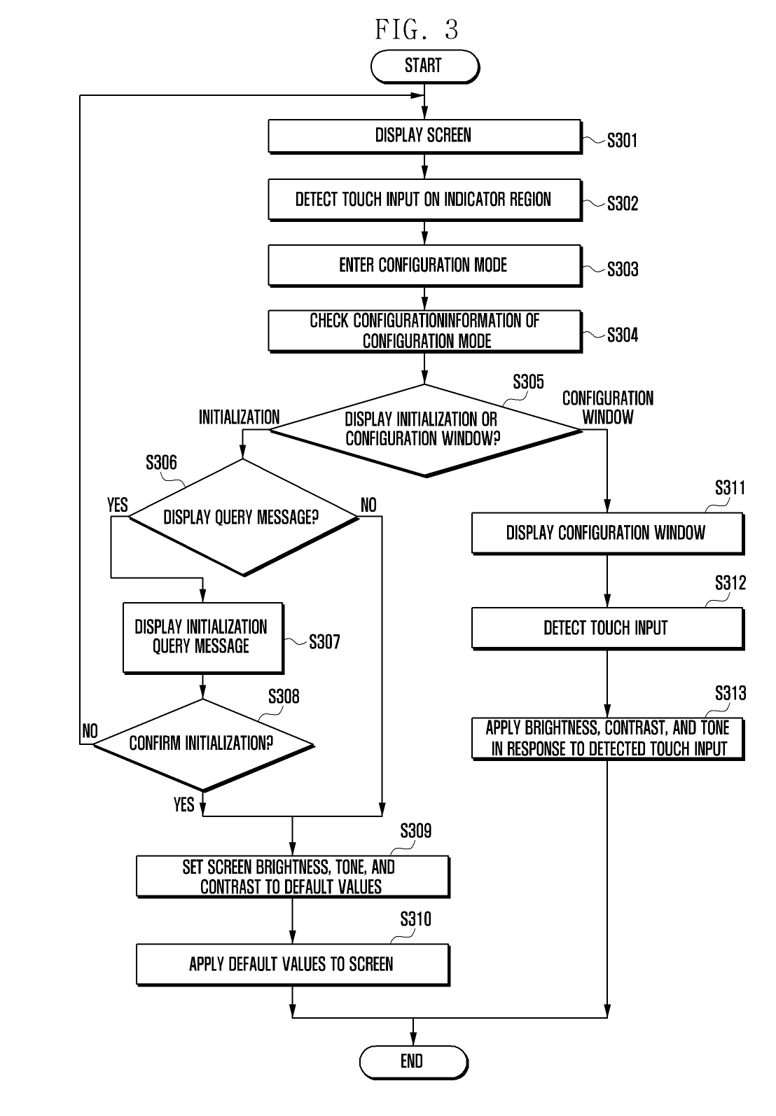

FIG. 3 is a flowchart of a process for configuring brightness adjustment mode and complementary adjustment mode capabilities of the terminal 100 according to aspects of the disclosure. Referring to FIG. 3, the control unit 130 controls the display unit 110 to power-on or wake-up from a power-saving mode (blackout state) at step S301. If a touch gesture is made at a certain position of the indicator region and maintained over predetermined time in the state that the screen has turned on, at step S302, the control unit causes the terminal 100 to enter a configuration mode for configuring the screen brightness, tone, and contrast at step S303.

The control unit 130 determines configuration information of the terminal 100 at step S304. The configuration information may be divided into screen brightness, contrast, and tone initialization information and contrast and tone configuration screen display information.

At step 305, the control unit 130 determines whether to perform initialization of the screen brightness, contrast, and tone or display the configuration screen for configuring the screen brightness, contrast, and tone according to the configuration information. If it is determined to initialize the screen brightness, contrast, and tone, the control unit 130 determines whether to display a screen brightness, contrast, and tone initialization query message at step S306. If it is determined to display the query message, the control unit 130 controls the display unit 110 to display a screen brightness, contrast, tone initialization query message requesting for confirmation at step S307. The control unit 130 determines whether a confirmation input is detected at step S308. If the confirmation input is detected at step S308 or if it is determined not to display the query message at step S306, the control unit 130 initializes the screen brightness, contrast, and tone to default values at step S309. The control unit 130 controls the display unit 110 to apply the default screen brightness level, contrast level, and tone level at step S310.

If it is determined to display the configuration screen for configuring the screen brightness, contrast, and tone at step S305, the control unit 130 controls the display unit 110 to display the configuration screen for configuration the screen brightness, tone, and contrast at step S311. The control unit 130 controls the display unit 110 to present an auto-brightness button and brightness adjustment configuration bar capable of adjusting the brightness of the screen on the configuration screen according to a user's touch (e.g., a swing touch). Particularly according to aspects of the present disclosure, the control unit 130 controls the display unit 110 to present a complementary adjustment mode activation button and an auto-tone/contrast button. The control unit 130 controls the display unit 110 to present the brightness adjustment configuration bar, tone adjustment configuration bar, and contrast adjustment configuration bar.

The control unit 130 detects the touches made on the buttons and configuration bars. For example, the control unit 130 may detect the activation of the auto-brightness button. In the case that the auto-brightness button is turned on, the control unit 130 may controls the brightness level on the brightness adjustment configuration bar to change according to the luminance information collected by the luminance information collection module 170. In the case that the auto-brightness button is turned off, the control unit may detect the touch gesture made on the brightness adjustment configuration bar. In the case that the auto-brightness button is turned off, the control unit 130 may detect the touch gesture for adjusting the screen brightness. The control unit 130 may detect the turn-on of the complementary adjustment mode activation button to activate the complementary adjustment mode. The control unit 130 also may detect the turn-on the auto-tone/contrast button. If the auto-brightness button is turned on, the control unit 130 may configure the tone adjustment configuration bar and contrast adjustment configuration bar to change in adaptation to the luminance information collected by the luminance information collection module 170. If the ambient luminance is so low that it is difficult to secure legibility with the lowest screen brightness, the control unit 130 may configure the screen display with additional reduction of the tone in the complementary adjustment mode. In contrast, if the ambient luminance is so high that it is difficult to secure legibility with the highest screen brightness, the control unit 130 may configure the screen display with additional increase of the contrast in the complementary adjustment mode. If the auto-brightness button is turned off and if the complementary adjustment mode activation is turned on, the control unit 130 may configure the display unit 110 to adjust the contrast and tone in the complementary adjustment mode according to the touch gesture made on the indicator region. If the auto tone/contrast button is turned off, the control unit may detect the touch input made with the tone adjustment configuration bar and contrast adjustment configuration bar.

The control unit 130 controls the display unit 110 to apply the screen brightness, contrast, and tone determined according to mode activation/deactivation, turn-on/off of the configuration bars, and touch gesture made on the configuration bars at step S313. In the case that the auto-brightness adjustment button is activated, the control unit 130 sets the brightness level on the brightness adjustment configuration bar automatically based on the luminance information collected by the luminance information collection module 170 and controls the brightness level to be set to the default value of the screen brightness. In the case that the auto-brightness button is turned off, the control unit 130 configures the brightness level of the brightness adjustment configuration bar as the default brightness of the screen and controls the display unit 130 to apply the default brightness.

According to one aspect of the disclosure, if the complementary adjustment mode activation button is turned on, the control unit 130 activates the complementary adjustment mode. If the auto tone/contrast button is turned on, the control unit 130 may configure the display unit 110 such that the tone and contrast of the complementary adjustment mode automatically according to the luminance information around the terminal which is collected by the luminance information collection module 170 and control the display unit 110 to apply the configured tone and contrast levels. In the case that the auto-tone/contrast button is turned off, the control unit 130 may control the display unit 110 to apply the tone level corresponding to the touch gesture made on the tone adjustment configuration bar and the contrast level corresponding to the touch gesture made on the contrast adjustment configuration bar. In the case that the auto-tone/contrast button is turned off, the control unit 130 may control the display unit 110 to apply the tone and contrast levels according to the touch gesture made on the indicator region.

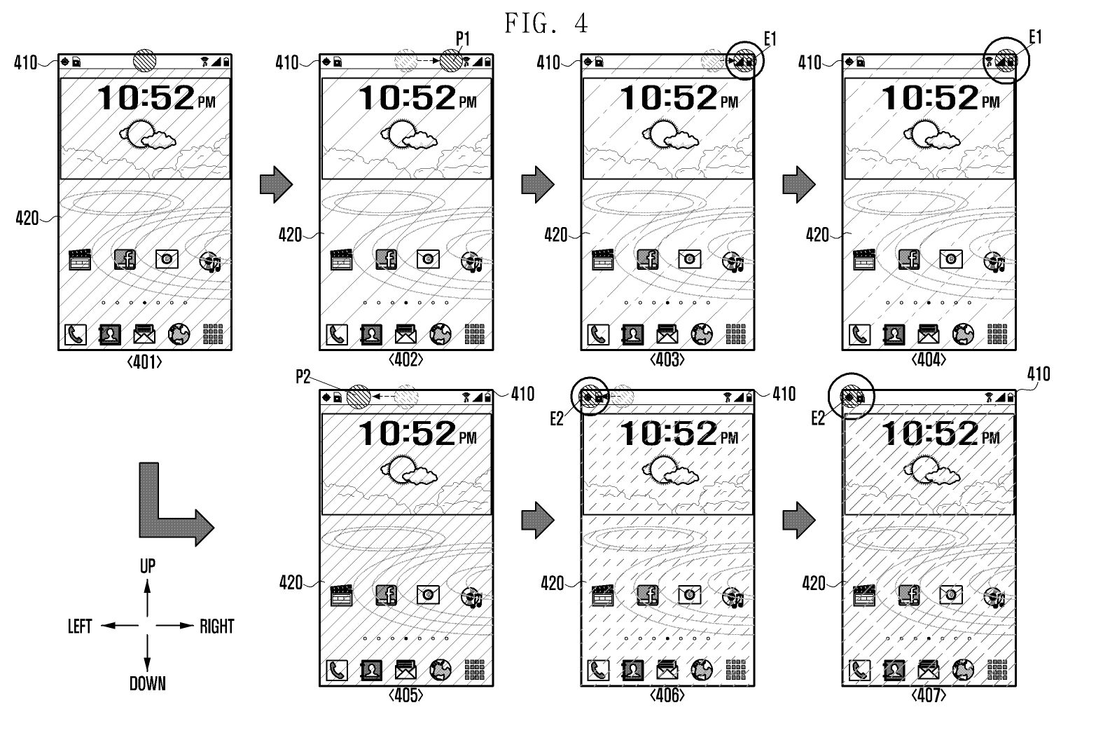

FIG. 4 is a diagram of an example technique for adjusting screen brightness, tone, and contrast according to aspects of the present disclosure. FIG. 4 shows a procedure for detecting a touch or touch gesture made in the indicator region 410 and adjusting the screen brightness, contrast, and tone in response to the touch or touch gesture. In this example, if the touch gesture progresses up to right or left end (E1 or E2) of the indicator region (highest or lowest level of the screen brightness) and stays over predetermined time, the control unit 130 regards this as the entry into the complementary adjustment mode. If the touch gesture is maintained after the entry into the complementary adjustment mode, the control unit 130 controls the terminal to enter the contrast or tone adjustment mode and increase the contrast or tone level in proportion to the time duration of the touch.

In the state of screen 401, the user may input a touch gesture in the indicator region 410, in order to increase the brightness of the display unit 110. More specifically, the user may slide his or her finger towards the point P1 of the indicator region 410 as shown in the screen 402. While this touch gesture is performed, as illustrated in the screens 401 and 402, the control unit 130 determines a brightness level that matches the current touch of the touch gesture (e.g., the current location of the user's finger as it is performing the gesture) and changes the brightness of the display unit 110 to a corresponding brightness level. In the example of screens 401 and 402, the screen brightness may increase, as indicated by the decreased density of the crosshatch of the screen 402.

The user may continuously slide his or her finger towards the point E1 of the indicator region 410 as shown in the screen 403. Moreover, if it is detected, by the control unit 130, that the touch gesture is maintained for a predetermined period of time in the state shown in the screen 403, the control unit 130 brings the terminal 100 into the complementary adjustment mode. At this time, the control unit 130 may cause the audio processing unit 160 to output an alarm sound to notify of transitioning from the brightness adjustment mode to the complementary adjustment mode, particularly, the contrast adjustment mode. Additionally or alternatively, the control unit 130 may also control the display unit 110 to display a notification message to notify of transitioning from the brightness adjustment mode to the complementary adjustment mode along with (or instead of) the tone alert.

After entering the complementary adjustment mode, if the user's finger remains, for a predetermined period of time, at the position shown in the screen 403, the control unit 130 may increase the contrast level of the display unit 110 in proportion to the time for which the user's finger has remained at that position (e.g., the time for which the user's finger has remained in that position in excess of the predetermined time). In the screen 403, the circle around the touch point indicates that this is the location where the user's finger performing the gesture has stopped moving, and the alternated long and short dashed lines indicate the increase of the contrast level of the display unit 110. In the screen 404, the size of circle around the touch point is further increased to indicate that the time for which the user's finger has stayed at its current location has increased further, and the change in the dash sequence of the dashed lines indicates a further increase of the contrast display unit 110 in response to the increased stay time.

In the state of the screen 401, if a touch gesture is detected in the indicator region 410 which proceeds as shown in the screen 405, the control unit 130 adjusts the brightness of the display unit in response. More specifically, the user may slide his or her finger towards the point P2 of the indicator region 410 as shown in the screen 405. The control unit 130 controls the display unit 110 to decrease the brightness level of the screen. The user may continuously slide his or her finger towards the point E2 of the indicator region 410 as shown in the screen 406. If it is detected that the user's finger performing the gesture remains at a given position for a predetermined period time, as shown in the screen 406, the control unit 130 regards this as a request for entry into the complementary adjustment mode. In the screen 407, the circle around the touch point is increased in size to indicate that the time for which the user's finger performing the gesture has remained at its current position has increased (i.e., an increase in the time for which the touch has been maintained at the current position) and that the tone of the display unit is further increased in response to the increased time. The increased dash length of the dashed lines, in this example, indicates an increase in the tone of the display unit 110.

The prior embodiment has been directed to the case where the screen brightness level increases to the highest level. However, it is possible to configure such that, when the touch gesture progresses in the way of increasing the screen brightness level and stays at the specific level over the predetermined time, the display unit 110 enters the complementary contrast adjustment mode to increase the contrast level. Likewise, it is possible to configure such that, when the touch gesture progresses in the way of decreasing the brightness level and stays at the specific level over the predetermined time, the display unit 110 enters the complementary tone mode to decrease the tone level.

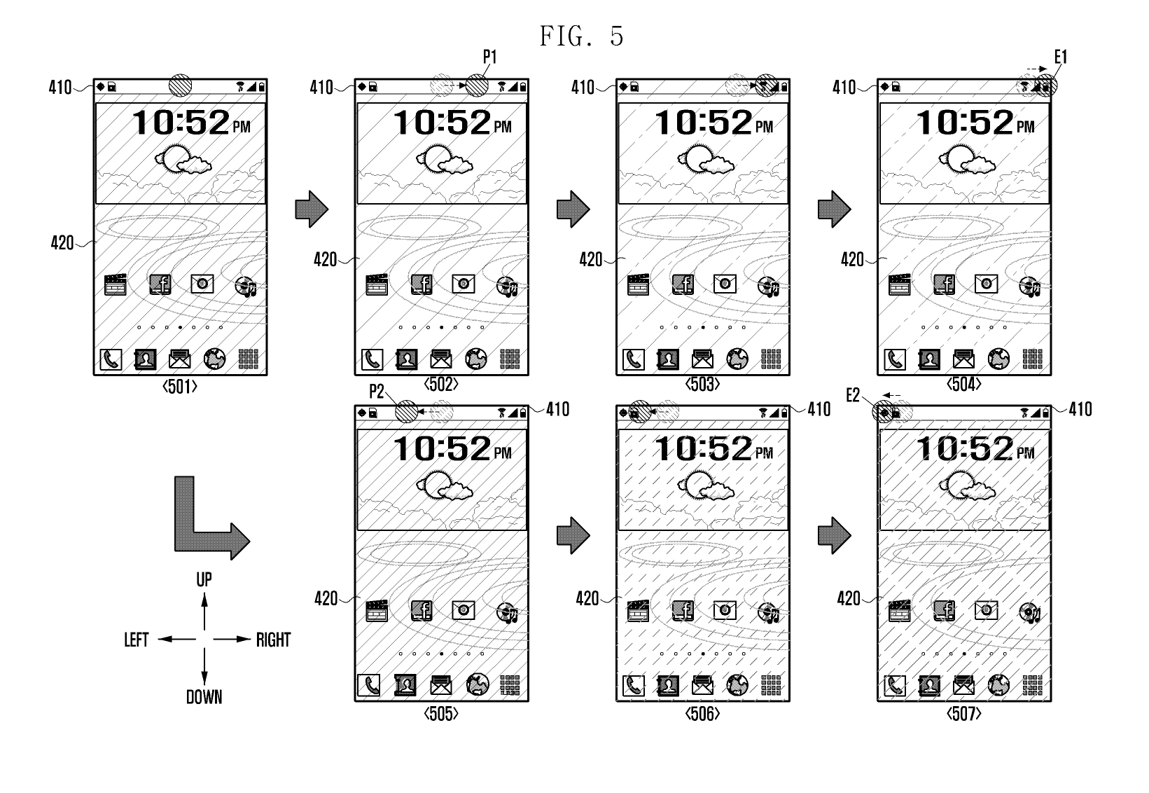

FIG. 5 is a diagram of another example technique for adjusting screen brightness, tone, and contrast in accordance with aspects of the present disclosure. In this example, the right part of the indicator region 410 is used for contrast adjustment in the complementary adjustment mode and the left part of the indicator region 410 is used for tone adjustment in the complementary adjustment mode. In this example, the control unit 130 may configure a point P1 in the right half of the indicator region 410 as the highest brightness level point and a point P2 in the left as the lowest brightness level point. A screen brightness adjustment mode region may thus be defined that spans between the points P1 and P2. Furthermore, a contrast adjustment region may be defined between the point P1 and the end E1 of the screen. And still furthermore, a tone adjustment region may be defined between the point P1 and the end E1 of the screen.

In the state of screen 501, the user may make a touch gesture progressing to the right to increase the brightness as shown in the screen 502. Assuming that the marked point P1 is the highest brightness level point in the screen 502, if the touch gesture progresses to the right passing the point P1, the display unit 110 enters the complementary adjustment mode, particularly, contrast adjustment mode. The screen 503 shows the device 100 in a complementary contrast adjustment mode. In this example, as the touch gesture progresses past the point P1, the contrast level increases. The screen 504 shows an example where the touch gesture progresses further to the right as compared to the example of the screen 503 such that the contrast level increases further.

In the state of the screen 501, the user may make a touch gesture progressing to the left on the indicator region 410 as shown in the screen 505 in order to decreases the screen brightness. Assuming that the marked point P2 is the lowest brightness level point in the screen 505, if the touch gesture progresses to the left passing point P2, the display unit enters the complementary adjustment mode. The screen 506 shows an example in which the device 100 is in a complementary tone adjustment mode. In this example, as the touch gesture progresses further to the left past the point P2, the tone level decreases. The screen 507 shows an example where the touch gesture progresses further to the left as compared to the example of the screen 506 such that the tone level decreases further.

In some implementations, the highest brightness point may be a point in the indicator region 410 that is associated with a maximum brightness level of the display unit 110, such that when this point is touched, the display unit 110 is set to the maximum brightness level. Additionally or alternatively, in some implementations, the lowest brightness point may be a point in the indicator region 410 that is associated with a minimum brightness level of the display unit 110, such that when this point is touched, the display unit 110 is set to the maximum brightness level. Although in this example, the highest and lowest brightness points are used as triggering points for entering in the complementary contrast and tone adjustment modes, in other examples any two points in the indicator region may be used as such trigger points.

As indicated above, in this example, the transition from the adjustment mode to the complementary adjustment mode is triggered by the touch gesture passing a predetermined point in the indicator region 410. Furthermore, in this example, the amount of change of the screen characteristic (e.g., tone level or contrast) is dependent upon a distance traveled by the touch gesture after the transition (e.g., a distance between the location of the first touch that is part of the gesture and the location of a second touch that is part of the gesture.)

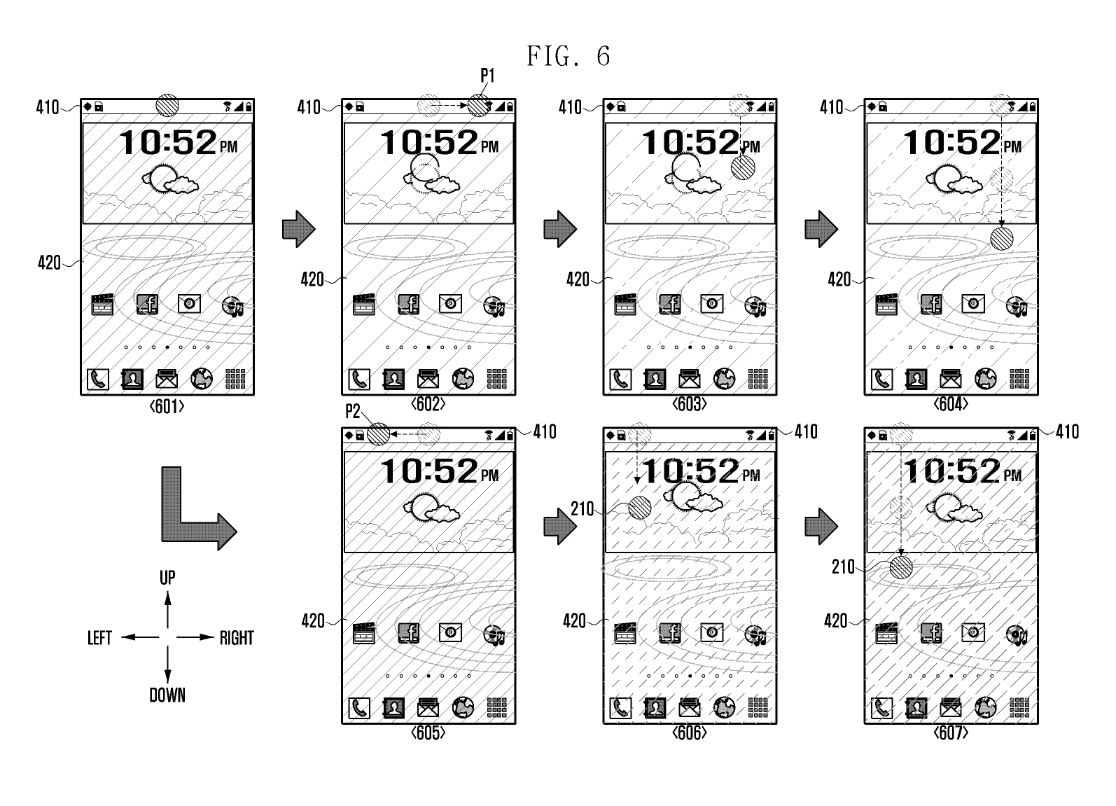

FIG. 6 is a diagram of yet another example technique for adjusting screen brightness, tone, and contrast in accordance with aspects of the present disclosure. In the state of the screen 601, the user may make a touch gesture on the indicator region 410. For example, the user may make a touch gesture progressing to the right on the indicator region 410 as shown in the display screen 602. At this time, it is assumed that the touch point P1 corresponds to the brightness level 5 in the screen 602. In the state of the screen 602, if the touch gesture moves downward from the indicator region 410, the display unit 110 transitions from the brightness adjustment mode to the complementary adjustment mode, particularly the contrast adjustment mode. The screen 603 shows the state where the touch gesture moves downward to the display region 420 so as to increase the contrast further relative to the contrast of state of the screen 602. The screen 604 shows the state where the touch gesture progresses further in the downward direction as compared to the state of the screen 603 such that the contrast level increases further. In some implementations, the amount of contrast level increase may be proportional to the distance passed by the touch gesture in the downward direction.

In the state of the screen 601, the user may make a touch gesture progressing to the left part of the indicator region 410 to decrease the screen brightness as shown in the screen 605. It is assumed that the touch point P2 corresponds to the brightness level 2 in the screen 605. If the touch gesture progresses to the downward direction from the indicator region 410 as shown in the screen 606 such that the display unit 110 enters the complementary adjustment mode, particularly tone adjustment mode, the control unit 130 activates the tone adjustment mode. The display screen 606 shows the state where the touch gesture progresses in a downward direction relative to the state of the screen 605 so as to decrease the tone further. The screen 607 corresponds to a state in which the touch gesture progresses further downward to decrease the tone level further. In some implementations, the amount of contrast level decrease may be proportional to the distance passed by the touch gesture in the downward direction.

As indicated above, in this example, the transition from the adjustment mode to the complementary adjustment mode is triggered by at least on of (1) change of the direction of the touch gesture's trajectory and the touch gesture exiting the indicator region 410 and entering the display region 420. Furthermore, in this example, the amount of change of the screen characteristic (e.g., tone level or contrast) is dependent upon a distance traveled by the touch gesture after the transition (e.g., a distance between the location of the first touch that is part of the gesture and the location of a second touch that is part of the gesture.)

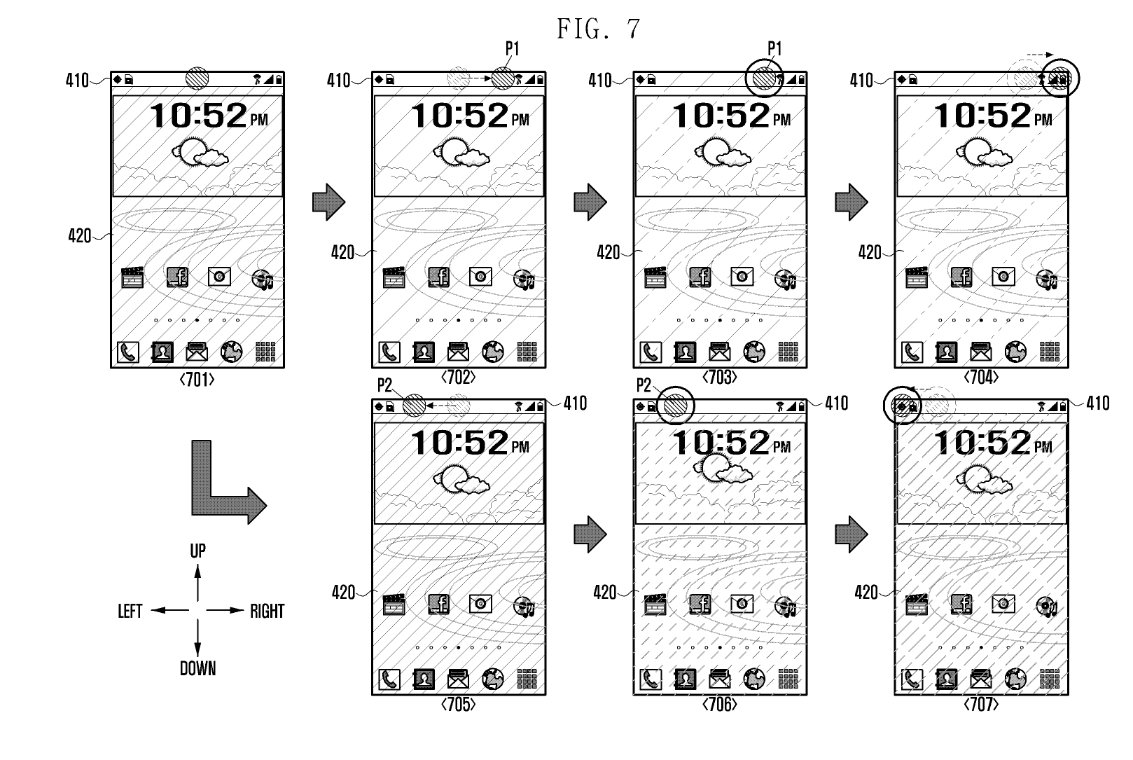

FIG. 7 is a diagram of yet another example technique for adjusting screen brightness, tone, and contrast in accordance with aspects of the present disclosure. In the state of the screen 701, if a touch or touch gesture is detected on the indicator region 410 as shown in the screen 702, the control unit determines the brightness level at the point P1 where the touch gesture stays and controls the display unit 110 to apply a corresponding brightness to the screen. For example, the brightness of the display unit 110 may be increased from level 3, in the state of the screen 701, to level 5, in the state of the screen 702, by the control unit 130.

In the state of the screen 702, if the touch gesture stays at its current location for a predetermined period of time, the control unit 130 regards this as the request for entry to bring the terminal 110 into a complementary adjustment mode. The screen 703 shows the state where the touch gesture progresses to the right further after the entry into the complementary adjustment mode as shown in the state of the screen 702 so as to increase the contrast level. The screen 704 shows the state where the touch gesture progresses further to the right from the state of the screen 703 so as to increase the contrast level further.

In the state of the screen 701, if a touch or touch gesture is detected in the indicator region 410 that moves in the direction shown in the screen 705, the control unit 130 may decrease the current brightness level corresponding to the point P2 of the display unit 110 (e.g., from level 3 to level 2). At this time, if the touch gesture remains at the position shown in the screen 705 for a predetermined time, the control unit 130 causes the terminal 110 to enter the complementary adjustment mode. In the complementary adjustment mode, as shown in the screen 706, if the touch gesture progresses to the left on the indicator region 410, the control unit 130 decreases the tone level in proportion to the progressing distance. The screen 707 shows the state where the touch gesture progresses further to the left so as to decrease the tone further proportionally.

As indicated above, in this example, the transition from the adjustment mode to the complementary adjustment mode depends on the time for which a first touch that is part of the gesture is maintained, while being independent of the location of the first touch. Furthermore, in this example, the amount of change of the screen characteristic (e.g., tone level or contrast) is dependent upon a distance traveled by the touch gesture after passing the first touch location (e.g., a distance between the location of the first touch and the location of a current touch that is part of the gesture.)

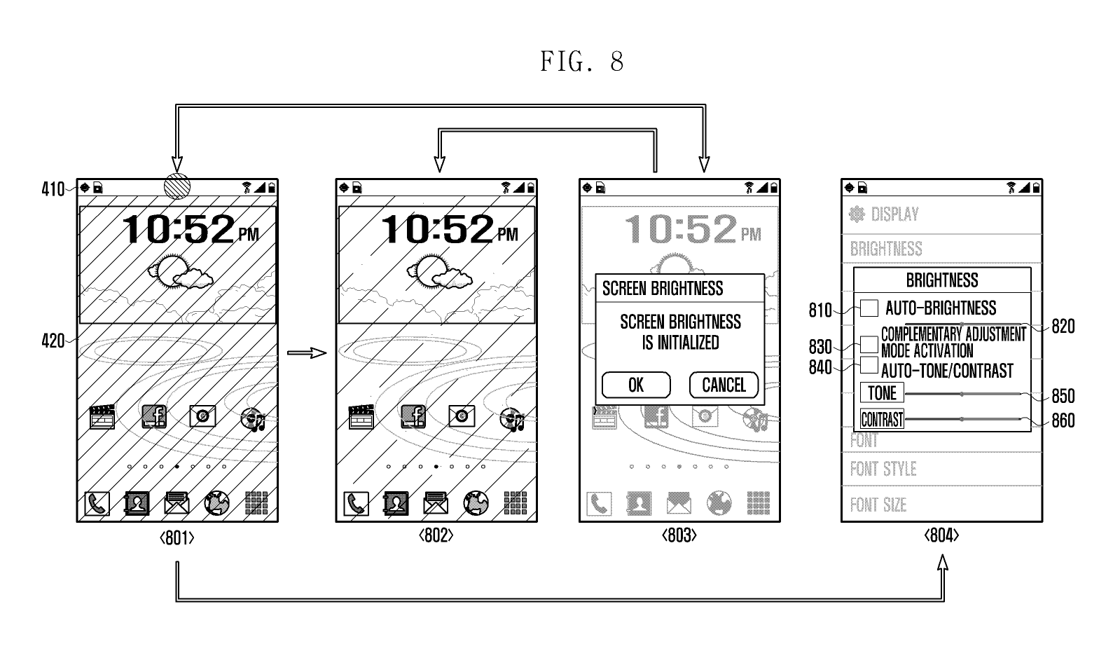

FIG. 8 is a diagram illustrating screen displays for explaining initialization and configuration of the brightness adjustment mode according to aspects of the present disclosure. The description is made under the assumption that the screen 801 shows the state where the screen brightness is adjusted according to the operation of the screen brightness adjustment mode as described with reference to FIG. 2, the contrast or tone is adjusted according the operation of the complementary adjustment mode, the brightness level of the screen 801 is 3, default screen brightness level is 6, default contrast is 50%, and default tone is 0%. If a touch gesture is detected at a certain point of the indicator region 410 and stays there for a predetermined time, the control unit 130 controls the display unit 110 to enter the initialization mode for presenting an initialization or configuration screen. The configuration information of the initialization mode may indicate screen brightness, contrast, and tone initialization and the contrast and tone configuration. The screen 802 shows the state where the initialization has been performed without displaying any initialization query message at the default screen brightness level 6 and contrast level of 50%. The screen 803 shows the case when the initialization query message is presented to the user. If the user makes a touch onto the OK button, the screen brightness level is initialized to the default level as shown in the screen 802. If the user makes a touch onto the cancel button, the screen brightness is set to the brightness level of the state of the screen 801 as the current screen brightness level (level 3).

The screen 804 shows the screen brightness configuration window. The configuration window is provided with an auto-brightness item 810 with a brightness adjustment scroll bar 820 for adjusting the brightness of the screen. Particularly in an embodiment of the present disclosure, if the auto-brightness item 810 is checked, the control unit 130 disables the brightness adjustment scroll bar 820 to block the manual adjustment of the user. If the auto-brightness button 810 is not checked, the control unit 130 detects a touch gesture made on the brightness adjustment scroll bar to check and apply the brightness level. At this time, the control unit 130 configures the brightness level set by the brightness adjustment scroll bar 820 as the default brightness.

According to aspects of the present disclosure, if the complementary adjustment mode activation item 830 is checked, the control unit 130 activates the complementary adjustment mode. If the auto-tone/contrast item 840 is checked, the control unit 130 adjusts the tone and contrast levels automatically in the complementary adjustment mode according to the ambient luminance information collected by the luminance information collection module 170 around the terminal 100 and an applies the tone level and contrast level configured in adaptation to the ambient environment to the screen. If the auto-tone/contrast item 840 is unchecked, the control unit 130 sets the tone level according to the touch gesture. Similarly, the control unit 130 may set the contrast level of the display unit 110 based on the contrast adjustment scroll bar 860. If the tone/contrast item 840 is unchecked, by entering into the complementary tone/contrast adjustment modes as discussed with respect to FIG. 2.

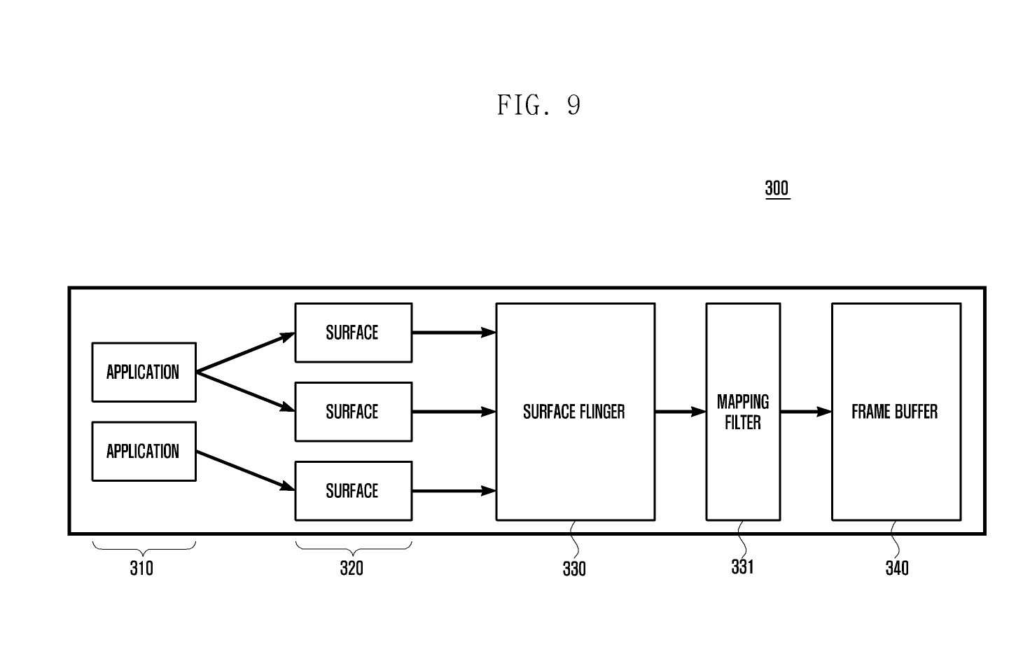

FIG. 9 is a block diagram illustrating a configuration of a graphics system for adjusting tone and contrast in a complementary adjustment mode of the terminal 100 according to aspects of the present disclosure. As shown in FIG. 9, the graphics system 300 includes applications 310 at the top layer. The system 300 generates the surface 320 for the application 310 requesting for a window. The surface 320 is responsible for constant drawing such as 3 Dimensional (3D) acceleration, camera, and game of the application 310, and one application 310 generates at least one surface 320. The surface flinger 330 is responsible for managing the surfaces 320 as the windows generated by the applications 310 integrally. The surface flinger 330 combines the plural surfaces 320 into one surface 320, generates a frame buffer 340 by associating the surface 320 with a frame buffer driver, and displays the buffered data on the screen of the display unit. The mapping filter 331 may be configured to display the data on screen where the tone and contrast have been adjusted in the complementary adjustment mode according to aspects of the present disclosure when the surface flinger 330 is mapped to the frame buffer 340. When it is concerned about the degradation on the screen, the mapping filter 331 may adjust the color whenever there is update services 320. Meanwhile, adjusting the tone or contrast may be decoding color.

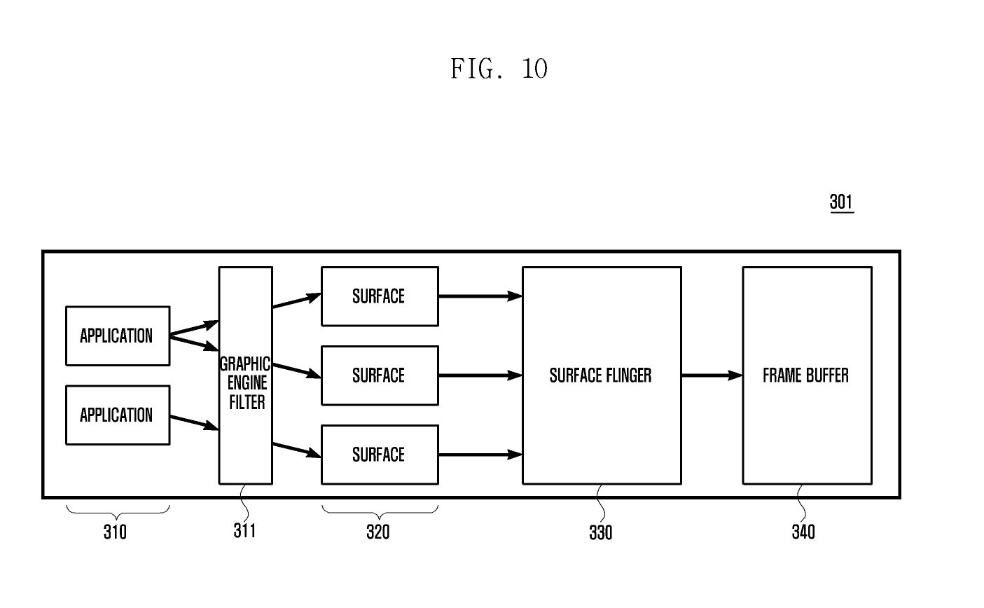

FIG. 10 is a block diagram illustrating a configuration of a graphics system for adjusting tone and contrast in a complementary adjustment mode of the terminal 100 according to aspects of the present disclosure. As shown in FIG. 10, the graphics system 301 includes applications 310 at the top layer. When the system generates surface 320 corresponding to the applications requesting for window, a graphic engine filter 311 adjusts paint color in painting of each view so as to perform painting to the surface. That is, the system decodes the painted colors and applies the colors to the surface. In the case of still/motion picture, it is possible to minimize performance degradation by adjusting the color in decoding each frame. The surface flinger 330 combines the surfaces 320 as the windows generated by the applications 310 to manage integrally. The surface flinger 330 combines plural surfaces 320 processed by the graphic engine filter 311 into one surface 320, generates a frame buffer by associating the surfaces 320 with the frame buffer driver, and displays the buffer data on the screen of the display unit 110.

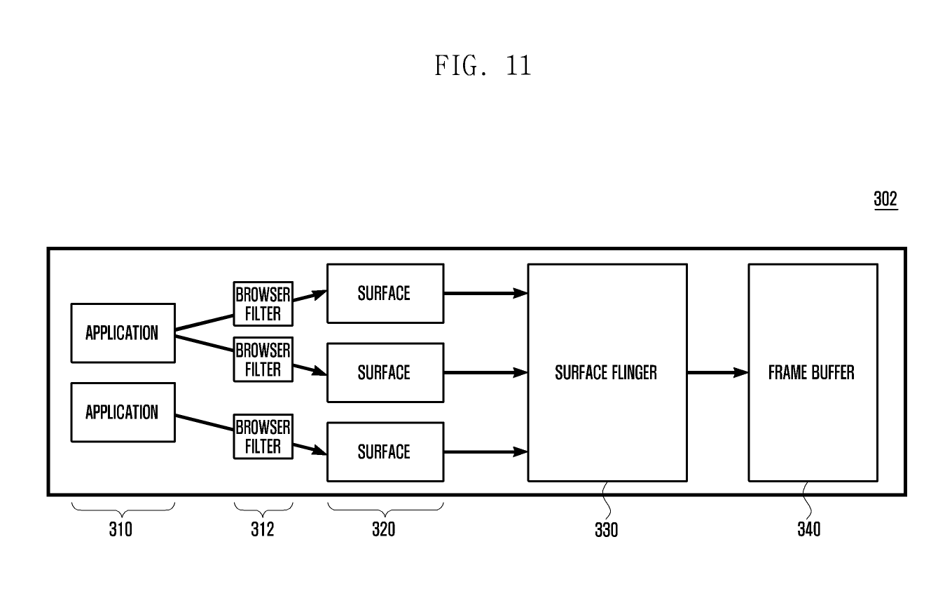

FIG. 11 is a block diagram illustrating a configuration of a graphics system for adjusting tone and contrast in a complementary adjustment mode of the terminal according to aspects of the present disclosure. Referring to FIG. 11, the graphics system 301 includes applications 310 at the top layer. The system 300 generates the surface 320 for the application 310 requesting for a window and, at this time, each browser filter 312 applies the color adjusted in painting at a web core to the background/characters and the tone and contrast to each surface 320 in the way of adjusting the color at the timing of completing the load of image/video. That is, the browser filter 312 is capable of painting the colors decoded in the web core's painting to the surfaces 320 and painting the colors decoded at the time when the data of the image/video has completed. The surface 320 may adjust the tone and contrast by means of the browser filter 312 processing the surfaces 320 when processing continuous draw such as 3D acceleration process, camera, and game of the applications 310.

The surface flinger 330 is responsible for managing the surfaces 320 as the windows generated by the applications 310 integrally. The surface flinger 330 combines the plural surfaces 320 processed by the browser filter 312 into one surface 320, generates a frame buffer 340 by associating the combined surface 320 with a frame buffer driver, and displays the buffered data on the screen of the display unit 110.

Although the display control method and apparatus of a terminal according to an embodiment of the present disclosure have been described using specific terms, the specification and drawings are to be regarded in an illustrative rather than a restrictive sense in order to help understand the present disclosure. It is obvious to those skilled in the art that various modifications and changes can be made thereto without departing from the broader spirit and scope of the disclosure.

It should be noted that FIGS. 1-11 are provided as examples only. Some of the steps shown in FIGS. 2 and 3 can be performed in a different order, concurrently, or altogether omitted. Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “in accordance with one aspect,” “such as,” “including” and the like) should not be interpreted as limiting the disclosure to the specific examples; rather, the examples are intended to illustrate only one of many possible embodiments.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

What is claimed is:

1. A method for adjusting a touch screen display of a terminal, the method comprising:
adjusting, by a processor, a brightness level of the display based on a direction of a touch gesture performed in a predetermined region of the display;
adjusting a contrast level of the display in response to a first characteristic included in the touch gesture, when the touch gesture progresses in a direction of increasing the brightness level; and
adjusting a tone level of the display in response to a second characteristic included in the touch gesture, when the touch gesture progresses in a direction of decreasing the brightness level.

2. The method of claim 1, further comprising:
determining whether the touch gesture possess one of the first characteristic and the second characteristic based on at least one of a location and a duration of a first touch that is part of the touch gesture.

3. The method of claim 1, further comprising increasing the contrast level in proportion to time for which a touch that is part of the touch gesture is maintained at a given location in the predetermined region.

4. The method of claim 2, further comprising increasing the contrast level in proportion to a distance between the first touch and a second touch that is part of the touch gesture.

5. The method of claim 4, wherein the second touch is outside of the predetermined region of the display.

6. The method of claim 2, further comprising outputting an indication that the terminal has transitioned into a complementary adjustment mode when it is determined that the touch gesture possesses one of the first characteristic and the second characteristic.

7. A method for controlling multiple properties of an electronic device's display by using a single touch gesture, the method comprising:
responsive to detecting a touch gesture in a predetermined region of the display, entering by the electronic device into a primary adjustment mode, wherein the electronic device is configured to use the touch gesture as a basis for changing a first property of the display when the electronic device is in the primary adjustment mode; and
while the touch gesture is being performed, and responsive to detecting that the touch gesture possesses a predetermined characteristic, exiting the primary adjustment mode and entering a complementary adjustment mode by the electronic device, wherein the electronic device is configured to use the touch gesture as a basis for changing a second property of the display when the electronic device is in the complementary adjustment mode.

8. The method of claim 7, wherein the first property is one of a brightness level, a tone level, and a contrast level, and the second property is another one of the brightness level, tone level, and the contrast level.

9. The method of claim 7, further comprising determining whether the touch gesture possesses the predetermined characteristic based on a shift in a direction of the touch gesture.

10. The method of claim 7, further comprising determining whether the touch gesture possess the predetermined characteristic based on a first location of a first touch that is part of the touch gesture and a duration for which the first touch is maintained at the first location.

11. The method of claim 10, further comprising increasing a value of the second property in proportion to a distance between the first touch and a second touch that is part of the touch gesture.

12. The method of claim 11, wherein the second touch is performed at a second location outside of the predetermined region of the display.

13. The method of claim 7, further comprising increasing a value of the second property of the display in proportion to a duration for which a touch is maintained at a given location in the predetermined region of the display.

14. The method of claim 7, further comprising outputting, by the electronic device, an indication that the electronic device has transitioned into the complementary adjustment mode.

15. An apparatus comprising:
a display; and
a processor configured to:
responsive to detecting a touch gesture in a predetermined region of the display, enter into a primary adjustment mode, wherein the processor is operable to use the touch gesture as a basis for changing a first property of the display when the processor is in the primary adjustment mode; and
while the touch gesture is being performed, responsive to detecting that the touch gesture possesses a predetermined characteristic, exit the primary adjustment mode and enter a complementary adjustment mode, wherein the processor is operable to use the touch gesture as a basis for changing a second property of the display when the processor is in the complementary adjustment mode.

16. The apparatus of claim 15, wherein the first property is one of a brightness level, a tone level, and a contrast level, and the second property is another one of the brightness level, the tone level, and the contrast level.

17. The apparatus of claim 15, wherein the processor is further configured to determine whether the touch gesture possesses the predetermined characteristic based on a shift in a direction of the touch gesture.

18. The apparatus of claim 15, wherein the processor is further configured to determine whether the touch gesture possess the predetermined characteristic based on a first location of a first touch that is part of the touch gesture and a duration for which the first touch is maintained at the first location.

19. The apparatus of claim 18, wherein the processor is further configured to increase a value of the second property in proportion to a distance between the first touch and a second touch that is part of the touch gesture.

20. The apparatus of claim 19, wherein the processor is further configured to increase a value of the second property of the display in proportion to a duration for which a touch is maintained at a given location in the predetermined region of the display.
